(19) United States
(12) Patent Application Publication
(10) Pub. No.: US 2016/0103768 A1
(43) Pub. Date: Apr. 14, 2016

(54) TLB Management Method and Computer

(71) Applicant: Huawei Technologies Co., Ltd., Shenzhen (CN)

(72) Inventors: Tao Jiang, Beijing (CN); Rui Hou, Beijing (CN); Lele Zhang, Beijing (CN); Yi Zhang, Beijing (CN); Lixin Zhang, Beijing (CN)

(21) Appl. No.: 14/975,597

(22) Filed: Dec. 18, 2015

Related U.S. Application Data
(63) Continuation of application No. PCT/CN2014/080103, filed on Jun. 17, 2014.

(30) Foreign Application Priority Data
Jun. 20, 2013 (CN) 201310246392.5

(51) Int. Cl. G06F 12/10; G06F 12/12

(52) U.S. Cl. CPC G06F 12/1027; G06F 12/1009; G06F 12/121; G06F 2212/657; G06F 2212/68; G06F 2212/69

(57) ABSTRACT

A TLB management method and computer are provided. The method includes querying a TLB storage directory table using a VPID of a first VCPU as an index, to obtain an address of a TLB storage table corresponding to the first VCPU; then accessing, according to the address of the TLB storage table corresponding to the first VCPU, the TLB storage table corresponding to the first VCPU, and reading a valid TLB entry in the TLB storage table corresponding to the first VCPU into a physical TLB.

This application is a continuation of International Application No. PCT/CN2014/080103, filed on Jun. 17, 2014, which claims priority to Chinese Patent Application No. 201310246392.5, filed on Jun. 20, 2013, both of which are hereby incorporated by reference in their entireties.

### TECHNICAL FIELD

The present disclosure relates to the field of computer technologies, and in particular, to a translation lookaside buffer (TLB) management method and computer.

### BACKGROUND

In the prior art, a computer accesses a memory using a physical address of a memory unit. A majority of modern computers support paging memory management. An address of a memory unit generated under a condition of paging memory management is named a logical address, and the logical address must be translated into a physical address, so that a memory can be accessed. A correspondence between a logical address and a physical address is stored in a page table of a memory in a computer. If each translation from a logical address into a physical address requires accessing a page table in a memory, it takes a plenty of time. Therefore, a physical TLB is disposed in a computer to serve as an advanced cache of address translation, where the physical TLB stores some page table entries that are frequently used, where the page table entries are a subset of a page table. In this way, when a memory unit of the computer is accessed, the physical TLB can be first searched for a matched TLB entry for address translation; if the matched TLB entry cannot be found in the physical TLB, which is a TLB miss, the corresponding entry is searched for in the page table of the memory, thereby improving an address translation speed.

In a virtualization environment, multiple virtual CPUs (VCPUs) run in one computer, and a physical TLB of the computer is shared by the multiple VCPUs. A VCPU cannot use a page table entry of another VCPU to perform translation from a logical address into a physical address, and therefore a virtual processor identifier (VPID) technology is introduced. A VPID is a 16-bit domain and is used to uniquely identify a VCPU, and each TLB entry is associated with one VPID. When translation from a logical address into a physical address is performed, only when a VPID corresponding to a TLB entry is the same as a VPID of a currently running VCPU, the TLB entry can be used to translate a corresponding logical address into a physical address. It can be distinguished, by using a VPID, to which VCPU a TLB entry belongs.

A capacity of a physical TLB in a computer is fixed. In a virtualization environment, multiple VCPUs run in one computer, these VCPUs share a physical TLB of the computer, and the capacity of the physical TLB is equally divided among the VCPUs. A TLB entry stored in a physical TLB in an existing computer includes a TLB entry of each VCPU. However, only one VCPU runs on the computer at a time, and a TLB entry of another VCPU is not useful to the running VCPU but is still saved in the physical TLB, which results in a relatively large TLB miss rate.

### SUMMARY

Embodiments of the present invention provide a TLB management method and apparatus, and can reduce a TLB miss rate.

To achieve the foregoing objectives, the embodiments of the present invention use the following technical solutions.

According to a first aspect, a TLB management method is provided, including: querying a TLB storage directory table using a VPID of a first VCPU as an index, to obtain an address, in a memory area, of a TLB storage table corresponding to the first VCPU, where a quantity of entries in the TLB storage directory table is equal to a quantity of VCPUs, and the TLB storage directory table stores a VPID of each VCPU, and an address, in the memory area, of a TLB storage table corresponding to each VPID; and accessing, according to the address, in the memory area, of the TLB storage table corresponding to the first VCPU, the TLB storage table corresponding to the first VCPU, and reading a valid TLB entry in the TLB storage table corresponding to the first VCPU into a physical TLB, where each VCPU corresponds to one TLB storage table, and the TLB storage table stores a TLB entry and a validity flag corresponding to the TLB entry, and the validity flag is used to describe whether the TLB entry is valid.

With reference to the first aspect, in a first possible implementation manner, an address of the TLB storage directory table is stored in a register in a processor; or an address of the TLB storage directory table is stored in a global variable of an operating system kernel in a computer; and the querying a TLB storage directory table using a VPID of a first VCPU as an index includes: accessing the TLB storage directory table according to the address of the TLB storage directory table, and querying the TLB storage directory table using the VPID of the first VCPU as the index.

With reference to the first aspect, in a second possible implementation manner, the TLB storage directory table further stores a counter used to represent a quantity of entries in the TLB storage table corresponding to each VPID.

With reference to the first aspect or the first or the second possible implementation manner of the first aspect, in a third possible implementation manner, the reading a valid TLB entry in the TLB storage table corresponding to the first VCPU into a physical TLB includes: replacing an original TLB entry currently stored in the physical TLB with the valid TLB entry in the TLB storage table corresponding to the first VCPU; and saving the replaced original TLB entry currently stored in the physical TLB into a TLB storage table corresponding to a VPID that is corresponding to the replaced original TLB entry, and emptying the TLB storage table corresponding to the first VCPU.

With reference to any of the first aspect and the first to third possible implementation manner, in a fourth possible implementation manner, after the reading a valid TLB entry in the TLB storage table corresponding to the first VCPU into a physical TLB, the method further includes: when the first VCPU is running, if a TLB entry matching a logical address of a memory instruction of the first VCPU is not found in the physical TLB, accessing a page table to search for and obtain a page table entry matching the logical address of the first VCPU; and replacing a TLB entry in the physical TLB with the matched page table entry, and saving the replaced TLB entry into a TLB storage table corresponding to a VPID that is corresponding to the replaced TLB entry.

With reference to the fourth possible implementation manner, in a fifth possible implementation manner, the replacing a TLB entry in the physical TLB with the matched page table entry, and saving the replaced TLB entry into a TLB storage table corresponding to a VPID that is corresponding to the replaced TLB entry includes: when the physical TLB includes a TLB entry with a first replacement priority, replacing any TLB entry with the first replacement priority in the physical TLB with the matched page table entry; or when the physical TLB does not include a TLB entry with a first replacement priority, replacing any TLB entry with a second replacement priority in the physical TLB with the matched page table entry; and when the replaced TLB entry is a TLB entry with the first replacement priority, saving the replaced TLB entry into a TLB storage table corresponding to a VPID that is corresponding to the replaced TLB entry, where in the physical TLB, the TLB entry with the second replacement priority is a TLB entry corresponding to the VPID of the first VCPU, and the TLB entry with the first replacement priority is a TLB entry corresponding to a VPID of a VCPU other than the first VCPU.

With reference to the fifth possible implementation manner, in a sixth possible implementation manner, after the replacing any TLB entry with the first replacement priority in the physical TLB with the matched page table entry, and the saving the replaced TLB entry into a TLB storage table corresponding to a VPID that is corresponding to the replaced TLB entry, the method further includes: adding 1 to a counter, in the TLB storage directory table, of a quantity of entries in the TLB storage table corresponding to the VPID that is corresponding to the replaced TLB entry, and setting a validity flag corresponding to the replaced TLB entry saved in the TLB storage table corresponding to the VPID that is corresponding to the replaced TLB entry to valid.

With reference to the first aspect, in a seventh possible implementation manner, when an entry of the first VCPU in a page table is modified and the modified entry of the first VCPU is stored in the TLB storage table corresponding to the first VCPU, a validity flag corresponding to the modified entry of the first VCPU in the TLB storage table corresponding to the first VCPU is set to invalid.

According to a second aspect, a TLB management apparatus is further provided, including: a querying and obtaining unit, configured to query a TLB storage directory table using a VPID of a first VCPU as an index, to obtain an address, in a memory area, of a TLB storage table corresponding to the first VCPU, where a quantity of entries in the TLB storage directory table is equal to a quantity of VCPUs, and the TLB storage directory table stores a VPID of each VCPU, and an address, in the memory area, of a TLB storage table corresponding to each VPID; and an entry read-in unit, configured to access, according to the address that is of the TLB storage table corresponding to the first VCPU, that is in the memory area, and that is obtained by means of querying by the querying and obtaining unit, the TLB storage table corresponding to the first VCPU, and read a valid TLB entry in the TLB storage table corresponding to the first VCPU into a physical TLB, where each VCPU corresponds to one TLB storage table, and the TLB storage table stores a TLB entry and a validity flag corresponding to the TLB entry, and the validity flag is used to describe whether the TLB entry is valid.

With reference to the second aspect, in a first possible implementation manner, an address of the TLB storage directory table is stored in a register in a processor; or an address of the TLB storage directory table is stored in a global variable of an operating system kernel in a computer; and the querying and obtaining unit is specifically configured to access the TLB storage directory table according to the address of the TLB storage directory table, and then query the TLB storage directory table using the VPID of the first VCPU as the index.

With reference to the second aspect, in a second possible implementation manner, the entry read-in unit specifically includes: a replacement subunit and a saving subunit, where the replacement subunit is configured to access, according to the address, in the memory area, of the TLB storage table corresponding to the first VCPU, the TLB storage table corresponding to the first VCPU, and replace an original TLB entry currently stored in the physical TLB with the valid TLB entry in the TLB storage table corresponding to the first VCPU; and the saving subunit is configured to save the replaced original TLB entry currently stored in the physical TLB into a TLB storage table corresponding to a VPID that is corresponding to the replaced original TLB entry, and empty the TLB storage table corresponding to the first VCPU.

With reference to the second aspect, in a third possible implementation manner, the TLB storage directory table further stores a counter used to represent a quantity of entries in a TLB storage table corresponding to each VPID.

With reference to the second aspect or the first possible implementation manner or the second possible implementation manner, in a fourth possible implementation manner, the apparatus further includes: a match search unit and a replacing and saving unit, where the match search unit is configured to: when the first VCPU is running, search the physical TLB into which the entry read-in unit reads a TLB entry, for a TLB entry matching a logical address of a memory instruction of the first VCPU; and if the TLB entry matching the logical address of the memory instruction of the first VCPU is not found in the physical TLB, access a page table to search for and obtain a page table entry matching the logical address of the first VCPU; and the replacing and saving unit is configured to replace a TLB entry in the physical TLB with the matched page table entry found by the match search unit, and save the replaced TLB entry into a TLB storage table corresponding to a VPID that is corresponding to the replaced TLB entry.

With reference to the fourth possible implementation manner, in a fifth possible implementation manner, the replacing and saving unit is specifically configured to: when the physical TLB includes a TLB entry with a first replacement priority, replace any TLB entry with the first replacement priority in the physical TLB with the matched page table entry; or when the physical TLB does not include a TLB entry with a first replacement priority, replace any TLB entry with a second replacement priority in the physical TLB with the matched page table entry; and when the replaced TLB entry is a TLB entry with the first replacement priority, save the replaced TLB entry into a TLB storage table corresponding to a VPID that is corresponding to the replaced TLB entry, where in the physical TLB, the TLB entry with the second replacement priority is a TLB entry corresponding to the VPID of the first VCPU, and the TLB entry with the first replacement priority is a TLB entry corresponding to a VPID of a VCPU other than the first VCPU.

With reference to the fifth possible implementation, in a sixth possible implementation manner, the apparatus further includes an updating unit, where the updating unit is configured to add 1 to a counter, in the TLB storage directory table, of a quantity of entries in the TLB storage table corresponding to the VPID that is corresponding to the TLB entry replaced by the replacing and saving unit, and set a validity flag corresponding to the replaced TLB entry saved in the corresponding TLB storage table by the replacing and saving unit to valid.

With reference to the second aspect, in a seventh possible implementation manner, the apparatus further includes a setting unit, where the setting unit is configured to: when an entry of the first VCPU in a page table is modified and the modified entry of the first VCPU is stored in the TLB storage table corresponding to the first VCPU, set a validity flag corresponding to the modified entry of the first VCPU in the TLB storage table corresponding to the first VCPU to invalid.

In the TLB management method and apparatus provided in the foregoing technical solutions, one TLB storage table is assigned to each VCPU, where the TLB storage table is stored in a memory area, and an address, in the memory area, of each TLB storage table is stored in a TLB storage directory table. In this way, a computer can query the TLB storage directory table using a VPID of a first VCPU as an index, to obtain an address, in the memory area, of a TLB storage table corresponding to the first VCPU, and further access, according to the address, in the memory area, of the TLB storage table corresponding to the first VCPU, the TLB storage table corresponding to the first VCPU, and read a valid TLB entry in the TLB storage table corresponding to the first VCPU into a physical TLB. Compared with the prior art in which a physical TLB is shared by all VCPUs, in the present disclosure, when each VCPU performs address translation, the physical TLB stores all valid TLB entries in a TLB storage table corresponding to the VCPU, thereby significantly reducing a TLB miss rate.

### BRIEF DESCRIPTION OF THE DRAWINGS

FIG. 1 is a schematic flowchart of a TLB management method according to an embodiment of the present invention;

FIG. 2 is a schematic flowchart of another TLB management method according to an embodiment of the present invention;

FIG. 3 is a schematic structural diagram of data in a TLB management method according to an embodiment of the present invention;

FIG. 4 is a structural block diagram of a TLB management apparatus according to an embodiment of the present invention;

FIG. 5 is a structural block diagram of another TLB management apparatus according to an embodiment of the present invention; and

FIG. 6 is a structural block diagram of another TLB management apparatus according to an embodiment of the present invention.

### DETAILED DESCRIPTION OF ILLUSTRATIVE EMBODIMENTS

The following describes methods and apparatuses provided in embodiments of the present invention in detail with reference to accompanying drawings. The described embodiments are merely some but not all of the embodiments of the present invention. All other embodiments obtained by a person of ordinary skill in the art based on the embodiments of the present invention without creative efforts shall fall within the protection scope of the present invention.

A translation lookaside buffer (TLB, or named page table buffer) stores some page table files. A page table refers to a table for translating a virtual address into a physical address, where the physical address refers to an address identified by a memory unit, and a linear address or the logical address refers to an address generated by a central processing unit (CPU). Generally, a logical address generated by a CPU is divided into: p (page number) and d (page offset), where p includes a base address, in a physical memory, of each page, and is used as an index of a page table, and d is used in combination with the base address to determine a physical memory address that is sent to a memory device.

In an embodiment, a TLB entry includes the following three parts: a VPID, a logical address, and a physical address. The VPID can be used to distinguish to which VCPU a TLB entry belongs; only when the VPID and the logical address are both matched, correct address translation can be performed to obtain the corresponding physical address.

### Embodiment 1

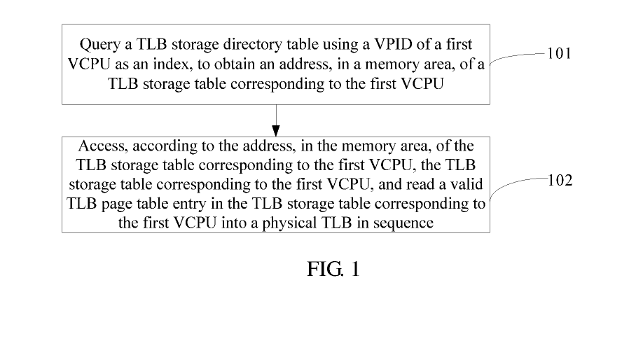

This embodiment of the present invention provides a TLB management method. As shown in FIG. 1, the method includes the following steps.

101. Query a TLB storage directory table using a VPID of a first VCPU as an index, to obtain an address, in a memory area, of a TLB storage table corresponding to the first VCPU.

A quantity of entries in the TLB storage directory table is equal to a quantity of VCPUs, and the TLB storage directory table stores a VPID of each VCPU in a computer, and an address, in the memory area, of a TLB storage table corresponding to each VPID.

102. Access, according to the address, in the memory area, of the TLB storage table corresponding to the first VCPU, the TLB storage table corresponding to the first VCPU, and read a valid TLB entry in the TLB storage table corresponding to the first VCPU into a physical TLB in sequence.

Each VCPU corresponds to one TLB storage table. The computer can access the TLB storage table corresponding to each VCPU according to the address of the TLB storage table, where the TLB storage table stores a TLB entry and a validity flag corresponding to the TLB entry, and the validity flag is used to describe whether the TLB entry is valid. When the validity flag is valid, it indicates that the TLB entry is valid. The valid TLB entry in the TLB storage table means that a validity flag of the TLB entry is valid.

In this embodiment of the present invention, each VCPU is assigned with one TLB storage table, which is used to store a TLB entry of the VCPU. The address, in the memory area, of the TLB storage table of each VCPU is stored in the TLB storage directory table, and can be searched for using the VPID of each VCPU as an index. In this way, before entering the first VCPU, the computer can search for the address, in the memory area, of the TLB storage table corresponding to the first VCPU using the VPID of the first VCPU as an index, and then access the TLB storage table, according to the address of the TLB storage table corresponding to the first VCPU, and read the valid TLB entry in the TLB storage table into the physical TLB in sequence.

According to the TLB management method provided in this embodiment of the present invention, one TLB storage table is assigned to each VCPU, where the TLB storage table is stored in a memory area, and an address, in the memory area, of each TLB storage table is stored in a TLB storage directory table. In this way, a computer can query the TLB storage directory table using a VPID of a first VCPU as an index, to obtain an address, in the memory area, of a TLB storage table corresponding to the first VCPU, and further access, according to the address, in the memory area, of the TLB storage table corresponding to the first VCPU, the TLB storage table corresponding to the first VCPU, and read a valid TLB entry in the TLB storage table corresponding to the first VCPU into a physical TLB in sequence. Compared with the prior art in which a physical TLB is shared by all VCPUs, in the present invention, when each VCPU performs address translation, the physical TLB stores all valid TLB entries in a TLB storage table corresponding to the VCPU, thereby significantly reducing a TLB miss rate.

### Embodiment 2

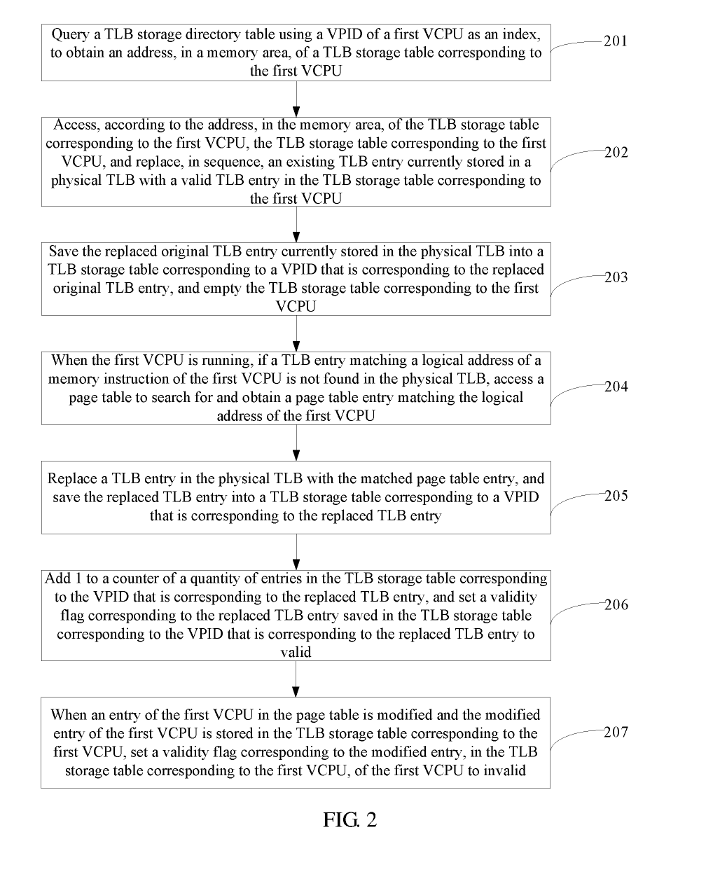

This embodiment of the present invention provides a TLB management method. As shown in FIG. 2, the method includes the following steps.

201. Query a TLB storage directory table using a VPID of a first VCPU as an index, to obtain an address, in a memory area, of a TLB storage table corresponding to the first VCPU.

An address of the TLB storage directory table may be stored in a register newly added to a CPU; or an address of the TLB storage directory table may be stored in a global variable of an operating system kernel in a computer. In this way, when performing VCPU scheduling, the computer can access the TLB storage directory table according to the address of the TLB storage directory table, and then query the TLB storage directory table using the VPID of the first VCPU as the index.

Optionally, the TLB storage directory table further stores a counter used to represent a quantity of entries in a TLB storage table corresponding to each VPID.

202. Access, according to the address, in the memory area, of the TLB storage table corresponding to the first VCPU, the TLB storage table corresponding to the first VCPU, and then replace an original TLB entry currently stored in a physical TLB with a valid TLB entry in the TLB storage table corresponding to the first VCPU.

It should be noted herein that one TLB entry in the TLB storage table corresponding to the first VCPU can replace only one original TLB entry in the physical TLB. A quantity of original TLB entries currently stored in the physical TLB is denoted by M, and a quantity of TLB entries in the TLB storage table corresponding to the first VCPU is denoted by N. When M is greater than N, after step 202 is performed, besides the TLB entry corresponding to the first VCPU, the physical TLB stores the original TLB entries in the physical TLB; when M is less than or equal to N, after step 202 is performed, the physical TLB stores only the TLB entry corresponding to the first VCPU.

203. Save the replaced original TLB entry currently stored in the physical TLB into a TLB storage table corresponding to a VPID that is corresponding to the replaced original TLB entry, and empty the TLB storage table corresponding to the first VCPU.

At the same time when step 202 is being performed, the replaced original TLB entry in the physical TLB is saved into the TLB storage table corresponding to the VPID that is corresponding to the replaced original TLB entry.

When all the valid TLB entries in the TLB storage table corresponding to the first VCPU are read into the physical TLB, the TLB storage table corresponding to the first VCPU needs to be emptied. In this way, when scheduling a VCPU to run, and shifting from a state of running the first VCPU to a state of running another VCPU, the computer can use a valid TLB entry in a TLB storage table corresponding to the another VCPU to replace the original TLB entry in the physical TLB, and save the original TLB entry in the physical TLB into the TLB storage table corresponding to the VPID that is corresponding to the replaced original TLB entry. In this way, the TLB entry corresponding to the first VCPU in the physical TLB can be saved into the emptied TLB storage table corresponding to the first VCPU.

Preferably, a quantity of entries that can be stored in each TLB storage table is equal to a quantity of entries that can be stored in the physical TLB.

It should be noted that steps 201 to 203 can be implemented in two manners. One is to be implemented by means of hardware: when performing VCPU scheduling, a computer needs to execute a VCPU entry instruction, and a function of the VCPU entry instruction may be extended herein to add the following functions to the VCPU entry instruction: querying the TLB storage directory table according to a VPID of a to-be-run VCPU, to obtain an address, in the memory area, of a TLB storage table corresponding to the VCPU, and reading a valid TLB entry, stored in the memory area, in the TLB storage table corresponding to the VCPU into a physical TLB in sequence. This kind of hardware implementation method is transparent to a system software developer, and the system software developer only needs to use one VCPU entry instruction. The other is to be implemented by means of software: before a VCPU entry instruction is executed, a TLB entry of a VCPU to be run on a computer can be read into the physical TLB from a TLB storage table in the memory area.

204. When the first VCPU is running, if a TLB entry matching a logical address of a memory instruction of the first VCPU is not found in the physical TLB, access a page table to search for and obtain a page table entry matching the logical address of the first VCPU.

When running the first VCPU, the computer receives the memory instruction of the VCPU, and requires a physical address of a memory unit to access a memory of the computer. In this case, the computer first searches the physical TLB for the TLB entry matching the logical address of the memory instruction of the first VCPU. If the TLB entry matching the logical address of the memory instruction of the first VCPU is found, address translation is performed according to the matched TLB entry to obtain a physical address corresponding to the memory instruction, so that a corresponding memory unit is accessed. If the TLB entry matching the logical address of the memory instruction of the first VCPU is not found, the page table is accessed to search for and obtain the page table entry matching the logical address of the first VCPU, and address translation is performed according to the matched page table entry to obtain a physical address corresponding to the memory instruction, so that a corresponding memory unit is accessed.

205. Replace a TLB entry in the physical TLB with the matched page table entry, and save the replaced TLB entry into a TLB storage table corresponding to a VPID that is corresponding to the replaced TLB entry.

In the physical TLB, the TLB entry corresponding to the VPID of the first VCPU is a TLB entry with a second replacement priority, and a TLB entry corresponding to a VPID of a VCPU other than the first VCPU is a TLB entry with a first replacement priority. When the physical TLB includes a TLB entry with the first replacement priority, any TLB entry with the first replacement priority in the physical TLB is replaced with the matched page table entry; or when the physical TLB does not include a TLB entry with the first replacement priority, any TLB entry with the second replacement priority in the physical TLB is replaced with the matched page table entry.

When the replaced TLB entry is a TLB entry with the first replacement priority, the replaced TLB entry is saved into a TLB storage table corresponding to a VPID that is corresponding to the replaced TLB entry.

It should be noted herein that if the replaced TLB entry is a TLB entry with the second replacement priority, it indicates that all TLB entries in the physical TLB are TLB entries corresponding to the first VCPU. The TLB storage table corresponding to the VPID of the first VCPU is emptied, and both the replacing and replaced TLB entries are TLB entries corresponding to the first VCPU; therefore, they do not need to be saved. If the replaced TLB entry is a TLB entry with the first replacement priority, the replaced TLB entry is a TLB entry corresponding to another VCPU. In this case, the replaced TLB entry needs to be saved into the TLB storage table corresponding to the VPID that is corresponding to the replaced TLB entry. After TLB entries in the physical TLB are replaced, these replaced TLB entries will not be lost as in the prior art, and are saved in a TLB storage table corresponding to a corresponding VPID. In this way, when the VCPU corresponding to the replaced TLB entry is running, the replaced TLB entry can still be read into the physical TLB, and address translation can be performed using the entry, thereby further reducing a TLB miss rate.

206. Add 1 to a counter of a quantity of entries in the TLB storage table corresponding to the VPID that is corresponding to the replaced TLB entry, and set a validity flag corresponding to the replaced TLB entry saved in the TLB storage table corresponding to the VPID that is corresponding to the replaced TLB entry to valid.

When the replaced TLB entry is a TLB entry with the first replacement priority, the replaced TLB entry is saved into a TLB storage table corresponding to a VPID that is corresponding to the replaced TLB entry. In this case, the computer adds 1 to the counter, in the TLB storage directory table, of a quantity of entries in the TLB storage table corresponding to the VPID that is corresponding to the replaced TLB entry, and sets the validity flag corresponding to the replaced TLB entry saved in the TLB storage table corresponding to the VPID that is corresponding to the replaced TLB entry to valid, so that the replaced TLB entry is read when a VCPU corresponding to the VPID runs next time.

207. When an entry of the first VCPU in the page table is modified and the modified entry of the first VCPU is stored in the TLB storage table corresponding to the first VCPU, set a validity flag corresponding to the modified entry, in the TLB storage table corresponding to the first VCPU, of the first VCPU to invalid.

If the modified entry of the first VCPU is not stored in the TLB storage table corresponding to the first VCPU, the TLB storage table corresponding to the first VCPU does not need to be modified.

If the computer modifies a page table entry of a particular VCPU, step 208 needs to be performed to ensure uniformity of TLB entries in the memory. Certainly, after a TLB entry in the page table is modified, if the TLB entry is saved in the physical TLB, the physical TLB needs to be refreshed.

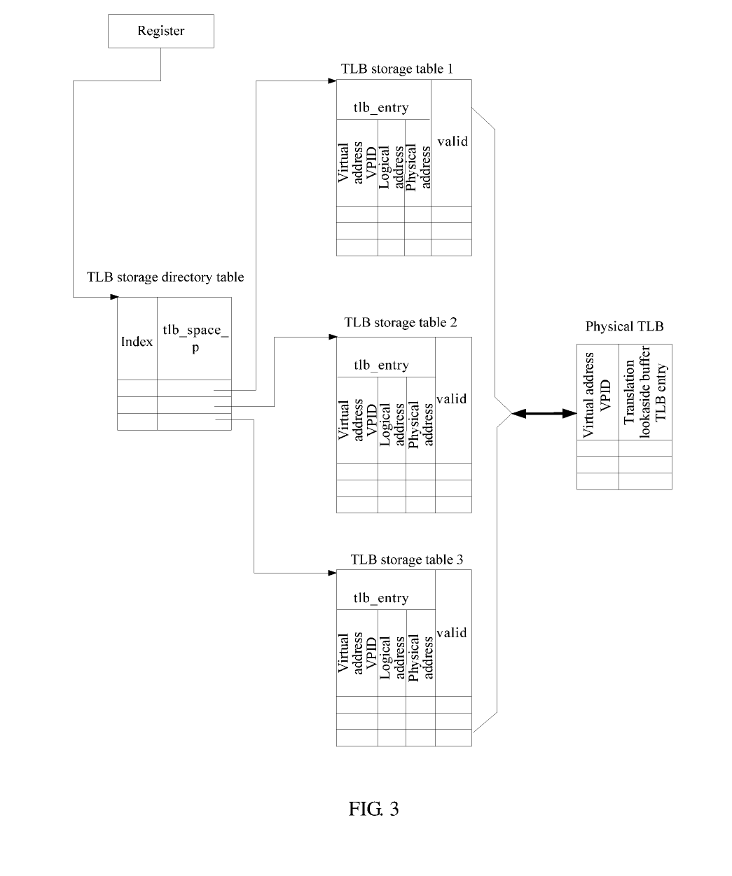

Exemplarily, a computer with an x86 structure is used as an example in the following for description. As shown in FIG. 3, FIG. 3 is a main data structure of the TLB management method according to this embodiment of the present invention, and the data structure mainly includes the TLB storage directory table, the TLB storage table, and the physical TLB. The address of the TLB storage directory table is stored in a register, and a quantity of entries in the TLB storage directory table is equal to a quantity of VCPUs in the computer. The TLB storage directory table consists of a tlb_space_p domain and an index domain, where the tlb_space_p domain stores an address, in the memory area, of a TLB storage table corresponding to each VCPU, and the index domain stores a counter used to represent a quantity of entries in the TLB storage table corresponding to each VPID. The TLB storage table consists of a tlb_entry domain and a valid domain, where the tlb_entry domain flag stores a TLB entry corresponding to a VCPU that is corresponding to the TLB storage table, and the valid domain is used to store a validity flag corresponding to each TLB entry. It is defined herein that a TLB storage table 1 stores 5 valid TLB entries corresponding to the first VCPU, a TLB storage table 2 stores 4 valid TLB entries and an invalid TLB entry that are corresponding to a second VCPU, and a TLB storage table 3 stores 3 valid TLB entries corresponding to a third VCPU. Both the TLB storage table and the physical TLB can store a maximum of 5 TLB entries.

The data structure is established during startup of the computer, and a TLB storage table is established in the memory area for each VCPU when the VCPU is established. An address of each TLB storage table is stored in the TLB storage directory table, and the register is added to save the address of the TLB storage directory table.

When the computer is about to run the first VCPU, a VCPU entry (VM-entry) instruction of x86 is extended, to add, to the instruction, a function that all the 5 valid TLB entries saved in the TLB storage directory table 1 corresponding to the first VCPU are read into the physical TLB. After the instruction is executed, the TLB storage directory table 1 is emptied, and only the TLB entries corresponding to the first VCPU are stored in the physical TLB. In this case, when the first VCPU is running, and when the TLB entry matching the logical address of the memory instruction of the first VCPU is found in the physical TLB, only the TLB entries corresponding to the first VCPU are stored in the physical TLB, which can reduce a TLB miss rate.

When the computer shifts from a state of running the first VCPU to a state of running the second VCPU, a VCPU entry instruction of x86 is also extended, to add, to the instruction, a function that all the 4 valid TLB entries saved in a TLB storage table 2 corresponding to the second VCPU are read into the physical TLB is added. During a read-in process, any four original replaced TLB entries, stored in the physical TLB, corresponding to the first VCPU, are saved into the TLB storage table 1 corresponding to the first VCPU, so that these TLB entries are used when the first VCPU runs next time. When the second VCPU is running, and when a TLB entry matching a logical address of a memory instruction of the second VCPU is found in the physical TLB, the physical TLB stores all the 4 TLB entries corresponding to the second VCPU stored in the TLB storage directory table 2, which can reduce a TLB miss rate. One TLB entry corresponding to the first VCPU is also saved; in this way, when the TLB entry matching the logical address of the memory instruction of the second VCPU is not found in the physical TLB, a matched page table entry is searched for in a page table. The TLB entry, saved in the physical TLB, corresponding to the first VCPU is replaced with the page table entry, and then the replaced TLB entry corresponding to the first VCPU is saved into the TLB storage table 1 corresponding to the first VCPU.

During an actual application process, a user mode of a native Linux (a local system) of x86 can also be considered as a VCPU, and a TLB storage table is established for the user mode. Before the computer enters the user mode of the native Linux through another VCPU, a valid TLB entry in the TLB storage table corresponding to the user mode of the native Linux is read into the physical TLB at a time. In this case, a kernel mode of the native Linux of the computer is used most frequently; therefore, a TLB entry corresponding to the kernel mode can be set as a TLB entry with the second replacement priority. In this way, these TLB entries will not be replaced.

According to the TLB management method provided in this embodiment of the present invention, one TLB storage directory table is queried using a VPID of a first VCPU as an index, to obtain an address, in a memory area, of a TLB storage table corresponding to the first VCPU; and the TLB storage table corresponding to the first VCPU is further accessed according to the address, in the memory area, of the TLB storage table corresponding to the first VCPU, and a valid TLB entry in the TLB storage table corresponding to the first VCPU is read into a physical TLB in sequence. Compared with the prior art in which a physical TLB is shared by all VCPUs, in the present disclosure, when each VCPU performs address translation, the physical TLB stores all valid TLB entries in a TLB storage table corresponding to the VCPU, thereby significantly reducing a TLB miss rate. In addition, after TLB entries in the physical TLB are replaced, these replaced TLB entries will not be lost as in the prior art, and are saved in TLB storage tables corresponding to corresponding VPIDs. In this way, when a VCPU corresponding to a replaced TLB entry is running, the replaced TLB entry can still be read into the physical TLB, so that the entry can be used to perform address translation, and the TLB miss rate can be further reduced.

### Embodiment 3

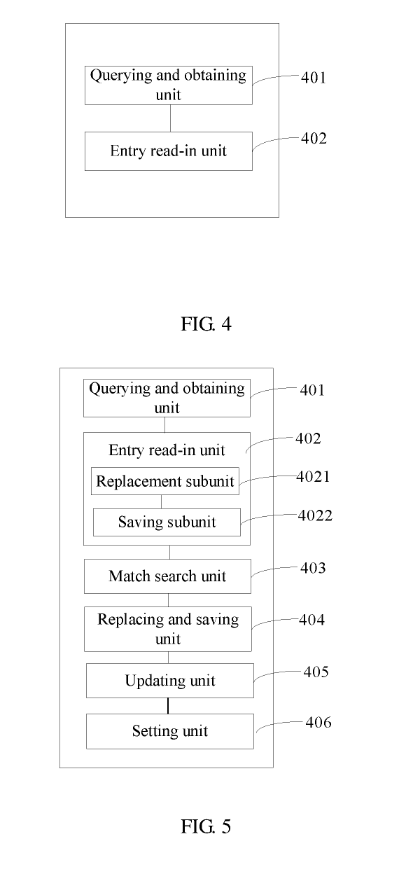

This embodiment of the present invention further provides an apparatus embodiment that implements the steps in the foregoing method embodiment, and this embodiment of the present invention can be applied to various computers. As shown in FIG. 4, the apparatus includes: a querying and obtaining unit 401 and an entry read-in unit 402.

The querying and obtaining unit 401 is configured to query a TLB storage directory table using a VPID of a first VCPU as an index, to obtain an address, in a memory area, of a TLB storage table corresponding to the first VCPU.

An address of the TLB storage directory table is stored in a register newly added to a CPU; or an address of the TLB storage directory table is stored in a global variable of an operating system kernel in a computer; and the querying and obtaining unit 401 is specifically configured to access the TLB storage directory table according to the address of the TLB storage directory table, and then query the TLB storage directory table using the VPID of the first VCPU as the index.

A quantity of entries in the TLB storage directory table is equal to a quantity of VCPUs, and the TLB storage directory table stores a VPID of each VCPU, and an address, in the memory area, of a TLB storage table corresponding to each VPID.

Optionally, a quantity of entries that can be stored in each TLB storage table is equal to a quantity of entries that can be stored in the physical TLB.

Optionally, the TLB storage directory table further stores a counter used to represent a quantity of entries in a TLB storage table corresponding to each VPID.

The entry read-in unit 402 is configured to: access, according to the address that is of the TLB storage table corresponding to the first VCPU, that is in the memory area, and that is obtained by means of querying by the querying and obtaining unit 401, the TLB storage table corresponding to the first VCPU, and read a valid TLB entry in the TLB storage table corresponding to the first VCPU into a physical TLB in sequence, where each VCPU corresponds to one TLB storage table, and the TLB storage table stores a TLB entry and a validity flag corresponding to the TLB entry, and the validity flag is used to describe whether the TLB entry is valid.

Optionally, as shown in FIG. 5, the entry read-in unit 402 specifically includes: a replacement subunit 4021 and a saving subunit 4022. The replacement subunit 4021 is configured to: access, according to the address, in the memory area, of the TLB storage table corresponding to the first VCPU, the TLB storage table corresponding to the first VCPU, and then replace, in sequence, an original TLB entry currently stored in the physical TLB with the valid TLB entry in the TLB storage table corresponding to the first VCPU. The saving subunit 4022 is configured to save the replaced original TLB entry currently stored in the physical TLB into a TLB storage table corresponding to a VPID that is corresponding to the replaced original TLB entry, and empty the TLB storage table corresponding to the first VCPU.

Further, as shown in FIG. 5, the apparatus further includes: a match search unit 403 and a replacing and saving unit 404.

The match search unit 403 is configured to: when the first VCPU is running, search the physical TLB into which the entry read-in unit 402 reads a TLB entry, for a TLB entry matching a logical address of a memory instruction of the first VCPU; and if the TLB entry matching the logical address of the memory instruction of the first VCPU is not found in the physical TLB, access a page table to search for and obtain a page table entry matching the logical address of the first VCPU.

The replacing and saving unit 404 is configured to replace a TLB entry in the physical TLB with the matched page table entry found by the match search unit 403, and save the replaced TLB entry into a TLB storage table corresponding to a VPID that is corresponding to the replaced TLB entry.

The replacing and saving unit 404 is specifically configured to: when the physical TLB includes a TLB entry with a first replacement priority, replace any TLB entry with the first replacement priority in the physical TLB with the matched page table entry; or when the physical TLB does not include a TLB entry with a first replacement priority, replace any TLB entry with a second replacement priority in the physical TLB with the matched page table entry; and when the replaced TLB entry is a TLB entry with the first replacement priority, save the replaced TLB entry into a TLB storage table corresponding to a VPID that is corresponding to the replaced TLB entry.

In the physical TLB, the TLB entry with the second replacement priority is a TLB entry corresponding to the VPID of the first VCPU, and the TLB entry with the first replacement priority is a TLB entry corresponding to a VPID of a VCPU other than the first VCPU.

Further, as shown in FIG. 5, the apparatus further includes: an updating unit 405, where the updating unit 405 is configured to add 1 to a counter, in the TLB storage directory table, of a quantity of entries in the TLB storage table corresponding to the VPID that is corresponding to the TLB entry replaced by the replacing and saving unit 404, and set a validity flag corresponding to the replaced TLB entry saved in the corresponding TLB storage table by the replacing and saving unit 404 to valid.

Further, as shown in FIG. 5, the apparatus further includes: a setting unit 406, where the setting unit 406 is configured to: when an entry of the first VCPU in a page table is modified and the modified entry of the first VCPU is stored in the TLB storage table corresponding to the first VCPU, set a validity flag corresponding to the modified entry of the first VCPU in the TLB storage table corresponding to the first VCPU to invalid.

In hardware implementation, the foregoing units can be embedded, in a form of hardware or in a form of software, in a processor of a computer. The processor can be a CPU, or can be a single-chip microcomputer.

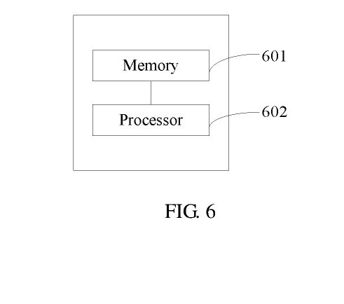

FIG. 6 is a schematic structural diagram of a computer according to this embodiment of the present invention. As shown in the figure, the computer includes a memory 601 and a processor 602 connected to the memory 601. Certainly, the computer may further include all kinds of general components, such as an interface, a receiver, a transmitter, an input/output apparatus, which are not limited herein in this embodiment of the present invention.

The memory 601 stores a set of program code, and the processor 602 is configured to invoke the program code stored in the memory 601, to execute the following operations: querying a TLB storage directory table using a virtual processor identifier VPID of a first virtual CPU VCPU as an index, to obtain an address, in a memory area, of a TLB storage table corresponding to the first VCPU, where a quantity of entries in the TLB storage directory table is equal to a quantity of VCPUs, and the TLB storage directory table stores a VPID of each VCPU, and an address, in the memory area, of a TLB storage table corresponding to each VPID.

The TLB storage directory table further stores a counter used to represent a quantity of entries in a TLB storage table corresponding to each VPID. A quantity of entries that can be stored in each TLB storage table is equal to a quantity of entries that can be stored in the physical TLB.

An address of the TLB storage directory table is stored in a register newly added to a CPU; or an address of the TLB storage directory table is stored in a global variable of an operating system kernel in a computer. In this case, the processor 602 is specifically configured to access the TLB storage directory table according to the address of the TLB storage directory table, and then query the TLB storage directory table using the VPID of the first VCPU as the index.

The processor 602 is further configured to: access, according to the address, in the memory area, of the TLB storage table corresponding to the first VCPU, the TLB storage table corresponding to the first VCPU, and read a valid TLB entry in the TLB storage table corresponding to the first VCPU into a physical TLB in sequence, where each VCPU corresponds to one TLB storage table, and the TLB storage table stores a TLB entry and a validity flag corresponding to the TLB entry, and the validity flag is used to describe whether the TLB entry is valid.

Optionally, the processor 602 is specifically configured to access, according to the address, in the memory area, of the TLB storage table corresponding to the first VCPU, the TLB storage table corresponding to the first VCPU, and then replace, in sequence, an original TLB entry currently stored in the physical TLB with the valid TLB entry in the TLB storage table corresponding to the first VCPU; and save the replaced original TLB entry currently stored in the physical TLB into a TLB storage table corresponding to a VPID that is corresponding to the replaced original TLB entry, and empty the TLB storage table corresponding to the first VCPU.

Further, the processor 602 is further configured to: when the first VCPU is running, search the physical TLB for a TLB entry matching a logical address of a memory instruction of the first VCPU, and if the TLB entry matching the logical address of the memory instruction of the first VCPU is not found in the physical TLB, access a page table to search for and obtain a page table entry matching the logical address of the first VCPU; and then replace a TLB entry in the physical TLB with the matched page table entry, and save the replaced TLB entry into a TLB storage table corresponding to a VPID that is corresponding to the replaced TLB entry.

Optionally, the processor 602 is specifically configured to: when the physical TLB includes a TLB entry with a first replacement priority, replace any TLB entry with the first replacement priority in the physical TLB with the matched page table entry; or when the physical TLB does not include a TLB entry with a first replacement priority, replace any TLB entry with a second replacement priority in the physical TLB with the matched page table entry; and when the replaced TLB entry is a TLB entry with the first replacement priority, save the replaced TLB entry into a TLB storage table corresponding to a VPID that is corresponding to the replaced TLB entry, where in the physical TLB, the TLB entry with the second replacement priority is a TLB entry corresponding to the VPID of the first VCPU, and the TLB entry with the first replacement priority is a TLB entry corresponding to a VPID of a VCPU other than the first VCPU.

Further, the processor 602 is further configured to add 1 to a counter, in the TLB storage directory table, of a quantity of entries in the TLB storage table corresponding to the VPID that is corresponding to the replaced TLB entry, and set a validity flag corresponding to the replaced TLB entry saved in the corresponding TLB storage table to valid.

The processor is further configured to: when an entry of the first VCPU in a page table is modified and the modified entry of the first VCPU is stored in the TLB storage table corresponding to the first VCPU, set a validity flag corresponding to the modified entry of the first VCPU in the TLB storage table corresponding to the first VCPU to invalid.

A person of ordinary skill in the art may understand that all or some of the steps of the method embodiments may be implemented by a program instructing relevant hardware. The program may be stored in a computer readable storage medium. When the program runs, the steps of the method embodiments are performed. The foregoing storage medium includes: any medium that can store program code, such as a read-only memory (ROM), a random access memory (RAM), a magnetic disk, or an optical disc.

The foregoing descriptions are merely specific implementation manners of the present disclosure, but are not intended to limit the protection scope of the present disclosure. Any variation or replacement readily figured out by a person skilled in the art within the technical scope disclosed in the present disclosure shall fall within the protection scope of the present disclosure. Therefore, the protection scope of the present disclosure shall be subject to the protection scope of the claims.

What is claimed is:

1. A translation lookaside buffer management method, comprising:
querying a translation lookaside buffer (TLB) storage directory table using a virtual processor identifier (VPID) of a first virtual CPU (VCPU), to obtain a memory address of a TLB storage table of the first VCPU, wherein one entry in the TLB storage directory table corresponds to one VCPU, each entry comprises a VPID of each VCPU and corresponding memory address of a TLB storage table of each VCPU;
accessing, according to the memory address of the TLB storage table of the first VCPU, the TLB storage table of the first VCPU; and
reading a valid TLB entry in the TLB storage table of the first VCPU into a physical TLB, wherein the TLB storage table stores a TLB entry and a validity flag corresponding to the TLB entry, and the validity flag is used to describe whether the TLB entry is valid.

2. The method according to claim 1, wherein an address of the TLB storage directory table is stored in a register in a processor; and
wherein querying the TLB storage directory table using a VPID of a first VCPU comprises accessing the TLB storage directory table according to the address of the TLB storage directory table, and querying the TLB storage directory table using the VPID of the first VCPU as an index.

3. The method according to claim 1, wherein an address of the TLB storage directory table is stored in a global variable of an operating system kernel in a computer; and
wherein querying the TLB storage directory table using a VPID of a first VCPU comprises accessing the TLB storage directory table according to the address of the TLB storage directory table, and querying the TLB storage directory table using the VPID of the first VCPU as an index.

4. The method according to claim 1, wherein the TLB storage directory table further stores a counter used to represent a quantity of entries in the TLB storage table corresponding to each VPID.

5. The method according to claim 1, wherein reading the valid TLB entry in the TLB storage table corresponding to the first VCPU into a physical TLB comprises:
replacing an original TLB entry currently stored in the physical TLB with the valid TLB entry in the TLB storage table corresponding to the first VCPU; and
saving the replaced original TLB entry currently stored in the physical TLB into a TLB storage table corresponding to a VPID that is corresponding to the replaced original TLB entry, and emptying the TLB storage table corresponding to the first VCPU.

6. The method according to claim 1, wherein the first VCPU is running, wherein a TLB entry matching a logical address of a memory instruction of the first VCPU is not found in the physical TLB, and wherein, after reading the valid TLB entry, the method further comprises:
accessing a page table to search for and obtain a page table entry matching the logical address of the first VCPU;
replacing a TLB entry in the physical TLB with the matched page table entry; and
saving the replaced TLB entry into a TLB storage table corresponding to a VPID that is corresponding to the replaced TLB entry.

7. The method according to claim 6, wherein replacing the TLB entry in the physical TLB and saving the replaced TLB entry into comprises:
when the physical TLB comprises a TLB entry with a first replacement priority, replacing any TLB entry with the first replacement priority in the physical TLB with the matched page table entry; and
when the physical TLB does not comprise a TLB entry with a first replacement priority, replacing any TLB entry with a second replacement priority in the physical TLB with the matched page table entry; and
when the replaced TLB entry is a TLB entry with the first replacement priority, saving the replaced TLB entry into a TLB storage table corresponding to a VPID that is corresponding to the replaced TLB entry;
wherein, in the physical TLB, the TLB entry with the second replacement priority is a TLB entry corresponding to the VPID of the first VCPU, and the TLB entry with the first replacement priority is a TLB entry corresponding to a VPID of a VCPU other than the first VCPU.

8. The method according to claim 7, wherein after replacing any TLB entry with the first replacement priority in the physical TLB with the matched page table entry and saving the replaced TLB entry into a TLB storage table corresponding to a VPID that is corresponding to the replaced TLB entry, the method further comprises:
adding 1 to a counter, in the TLB storage directory table, of a quantity of entries in the TLB storage table corresponding to the VPID that is corresponding to the replaced TLB entry, and setting a validity flag corresponding to the replaced TLB entry saved in the TLB storage table corresponding to the VPID that is corresponding to the replaced TLB entry to valid.

9. The method according to claim 1, wherein a quantity of entries that can be stored in each TLB storage table is equal to a quantity of entries that can be stored in the physical TLB.

10. The method according to claim 1, wherein an entry of the first VCPU in a page table is modified and the modified entry of the first VCPU is stored in the TLB storage table corresponding to the first VCPU, the method further comprising:
setting a validity flag corresponding to the modified entry of the first VCPU in the TLB storage table corresponding to the first VCPU to invalid.

11. A computer, comprising:
a processor; and
a memory coupled to the processor and storing a set of programming instructions for execution by the processor, wherein the programming instructions instruct the processor to:
query a translation lookaside buffer (TLB) storage directory table using a virtual processor identifier (VPID) of a first virtual CPU (VCPU), to obtain an address, in a memory area, of a TLB storage table corresponding to the first VCPU, wherein a quantity of entries in the TLB storage directory table is equal to a quantity of VCPUs, and the TLB storage directory table stores a VPID of each VCPU, and an address, in the memory area, of a TLB storage table corresponding to each VPID; and
access, according to the address that is of the TLB storage table corresponding to the first VCPU, the TLB storage table corresponding to the first VCPU, and read a valid TLB entry in the TLB storage table corresponding to the first VCPU into a physical TLB, wherein each VCPU corresponds to one TLB storage table, and the TLB storage table stores a TLB entry and a validity flag corresponding to the TLB entry, and the validity flag is used to describe whether the TLB entry is valid.

12. The computer according to claim 11, wherein an address of the TLB storage directory table is stored in a register in the processor, or an address of the TLB storage directory table is stored in a global variable of an operating system kernel in the computer; and
wherein the programming instructions instruct the processor to access the TLB storage directory table according to the address of the TLB storage directory table, and query the TLB storage directory table using the VPID of the first VCPU as an index.

13. The computer according to claim 11, wherein the TLB storage directory table further stores a counter used to represent a quantity of entries in the TLB storage table corresponding to each VPID.

14. The computer according to claim 11, wherein the programming instructions instruct the processor to:
access, according to the address, in the memory area, of the TLB storage table corresponding to the first VCPU, the TLB storage table corresponding to the first VCPU, and then replace an original TLB entry currently stored in the physical TLB with the valid TLB entry in the TLB storage table corresponding to the first VCPU; and
save the replaced original TLB entry currently stored in the physical TLB into a TLB storage table corresponding to a VPID that is corresponding to the replaced original TLB entry, and empty the TLB storage table corresponding to the first VCPU.

15. The computer according to claim 11, wherein the programming instructions instruct the processor to:
search the physical TLB into which a TLB entry read, for a TLB entry matching a logical address of a memory instruction of the first VCPU, when the first VCPU is running; and if the TLB entry matching the logical address of the memory instruction of the first VCPU is not found in the physical TLB, access a page table to search for and obtain a page table entry matching the logical address of the first VCPU; and
replace a TLB entry in the physical TLB with the matched page table entry, and save the replaced TLB entry into a TLB storage table corresponding to a VPID that is corresponding to the replaced TLB entry.

16. The computer according to claim 15, wherein the programming instructions instruct the processor to, when the physical TLB comprises a TLB entry with a first replacement priority, replace any TLB entry with the first replacement priority in the physical TLB with the matched page table entry; and when the physical TLB does not comprise a TLB entry with a first replacement priority, replace any TLB entry with a second replacement priority in the physical TLB with the matched page table entry; and when the replaced TLB entry is a TLB entry with the first replacement priority, save the replaced TLB entry into a TLB storage table corresponding to a VPID that is corresponding to the replaced TLB entry, wherein in the physical TLB, the TLB entry with the second replacement priority is a TLB entry corresponding to the VPID of the first VCPU, and the TLB entry with the first replacement priority is a TLB entry corresponding to a VPID of a VCPU other than the first VCPU.

17. The computer according to claim 16, wherein the programming instructions instruct the processor further to add 1 to a counter, in the TLB storage directory table, of a quantity of entries in the TLB storage table corresponding to the VPID that is corresponding to the replaced TLB entry, and set a validity flag corresponding to the replaced TLB entry saved in the corresponding TLB storage table to valid.

18. The computer according to claim 11, wherein a quantity of entries that can be stored in each TLB storage table is equal to a quantity of entries that can be stored in the physical TLB.

19. The computer according to claim 11, wherein the programming instructions instruct the processor further to, when an entry of the first VCPU in a page table is modified and the modified entry of the first VCPU is stored in the TLB storage table corresponding to the first VCPU, set a validity flag corresponding to the modified entry of the first VCPU in the TLB storage table corresponding to the first VCPU to invalid.
